(19) United States
(12) Patent Application Publication
(10) Pub. No.: US 2015/0103776 A1
(43) Pub. Date: Apr. 16, 2015

(54) EVENT DRIVEN ANONYMOUS DEVICE IDENTIFIER GENERATION

(71) Applicant: NearBuy Systems, Inc., San Mateo, CA (US)

(72) Inventors: Jason Luther, Montclair, NJ (US); Nathan Mueller, Mountain View, CA (US)

(21) Appl. No.: 14/485,110

(22) Filed: Sep. 12, 2014

Related U.S. Application Data
(60) Provisional application No. 61/891,871, filed on Oct. 16, 2013.

(51) Int. Cl. H04L 29/12; H04W 76/02

(52) U.S. Cl. CPC H04L 61/20; H04W 76/021
USPC 370/329

(57) ABSTRACT

In some implementations, a user can enable random device identifier generation on a mobile device. When random device identifier generation is enabled, the mobile device will generate random device identifiers in response to detecting a triggering event. The random device identifiers will be used to communicate with a network instead of the actual identifier of the mobile device. In some implementations, a data collection server can collect information about mobile devices, including actual mobile device identifiers. The data collection server can receive a request for the information collected about the mobile devices. In response to the request, the data collection server can generate a response to the requests that includes the mobile device information. In some implementations, when generating the response to the request, the data collection server can replace the actual device identifiers in the response with a random device identifier.

### CLAIM OF PRIORITY

This application claims priority to Provisional U.S. Patent Application No. 61/891,871, filed on Oct. 16, 2013, entitled “EVENT DRIVEN ANONYMOUS DEVICE IDENTIFIER GENERATION” by a Luther et al., which is incorporated herein by reference in its entirety and for all purposes.

### TECHNICAL FIELD

The disclosure generally relates to networking.

### BACKGROUND

Mobile devices are often configured for wireless networking. For example, a mobile device can include a transceiver for communicating with wireless networks. The mobile device can detect wireless network signals and request access to wireless networks using a device identifier (e.g., media access control “MAC” address) assigned to the mobile device. Often the wireless networks are configured to track device identifiers and collect other information (e.g., location information) about the mobile devices that connect to the wireless networks or to other wireless networks in the same area. The device identifier and location information can be correlated with other information to track and collect information about a user of the mobile device. For example, the tracking information can be used to determine how long a user stays in a store or which websites the user visits while connected to the network.

### SUMMARY

In some implementations, a user can enable random device identifier generation on a mobile device. When random device identifier generation is enabled, the mobile device will generate random device identifiers in response to detecting a triggering event. For example, a triggering event can include the passage of a period of time, changing networks, changing wireless access points, a distance traveled that exceeds a configured amount, a location change

In some implementations, a data collection server can collect information about mobile devices. The data collection server can collect mobile device identifiers, locations and other information associated with the mobile device identifier. The data collection server can receive a request for the information collected about the mobile devices. In response to the request, the data collection server can generate a response to the requests that includes the mobile device information. In some implementations, when generating the response to the request, the data collection server can replace the actual device identifiers in the response with a random device identifier.

Particular implementations provide at least the following advantages: User and device anonymity can be preserved while still allowing collection of important metrics that do not require user or device identification information.

Details of one or more implementations are set forth in the accompanying drawings and the description below. Other features, aspects, and potential advantages will be apparent from the description and drawings, and from the claims.

### DESCRIPTION OF DRAWINGS

FIG. 1 illustrates an example system for mobile device tracking.

FIG. 2 illustrates an example graphical user interface for presenting a warning about device tracking.

FIG. 3 illustrates an example graphical user interface for configuring network settings on a mobile device.

FIG. 4 illustrates an example system for tracking mobile devices.

FIG. 5 illustrates an example of mobile device tracking records.

FIG. 6 is flow diagram of an example process for generating anonymous device identifiers.

FIG. 7 is a flow diagram of an example process for obfuscating device identifiers when exporting tracking information.

FIG. 8 is a block diagram of an example computing device that can implement the features and processes of FIGS. 1-7.

Like reference symbols in the various drawings indicate like elements.

### DETAILED DESCRIPTION

This disclosure describes various Graphical User Interfaces (GUIs) for implementing various features, processes or workflows. These GUIs can be presented on a variety of electronic devices including but not limited to laptop computers, desktop computers, computer terminals, television systems, tablet computers, e-book readers and smart phones. One or more of these electronic devices can include a touch-sensitive surface. The touch-sensitive surface can process multiple simultaneous points of input, including processing data related to the pressure, degree or position of each point of input. Such processing can facilitate gestures with multiple fingers, including pinching and swiping.

When the disclosure refers to “select” or “selecting” user interface elements in a GUI, these terms are understood to include clicking or “hovering” with a mouse or other input device over a user interface element, or touching, tapping or gesturing with one or more fingers or stylus on a user interface element. User interface elements can be virtual buttons, menus, selectors, switches, sliders, scrubbers, knobs, thumbnails, links, icons, radio buttons, checkboxes and any other mechanism for receiving input from, or providing feedback to a user.

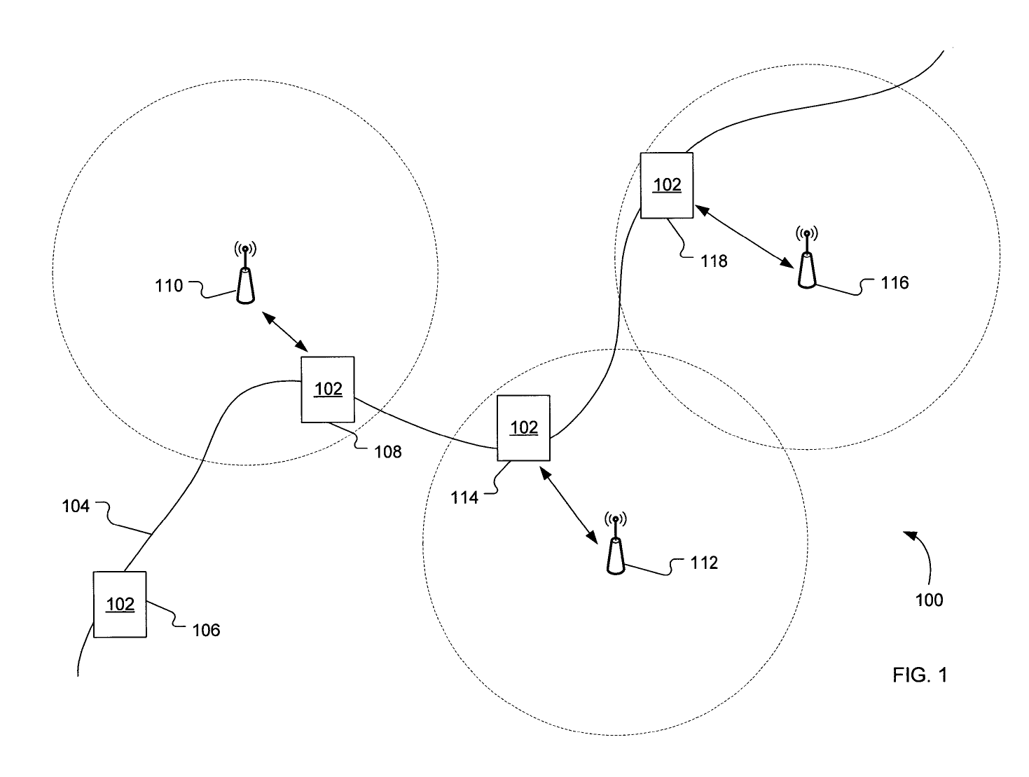

FIG. 1 illustrates an example system 100 for mobile device tracking. For example, mobile device 102 can include a networking transceiver for communicating with wireless networks. For example, the wireless networks can be based on Wi-Fi, Bluetooth or any other networking or communications technologies. As mobile device 102 moves along path 104 from location 106 to location 108, mobile device 102 can detect wireless network access point 110 for connecting to a network (not shown). For example, the mobile device 102 can broadcast a network probe request, including the device identifier (e.g., media access control “MAC” address) for mobile device 102. Access point 110 can respond to the probe request by sending to mobile device 102 information identifying the access point.

As mobile device 102 continues along path 104, mobile device 102 can communicate with wireless access point 112 at location 114 and wireless access point 116 at location 118. As the mobile device 102 moves from access point to access point, the access points can collect the device identifier of the mobile device (e.g., from the probe requests or connection requests). The access points can be connected to a centralized server that can correlate the device identifiers received each time mobile device 102 connects to or communicates with an access point associated with the server. By correlating the device identifiers, the time at which the mobile device 102 connected to each access point and the location of each access point, the server can approximate path 104. Thus, by sharing its device identifier with each access point, the mobile device 102 enables other devices (e.g., wireless access points, servers, etc.) to track the location of the mobile device 102.

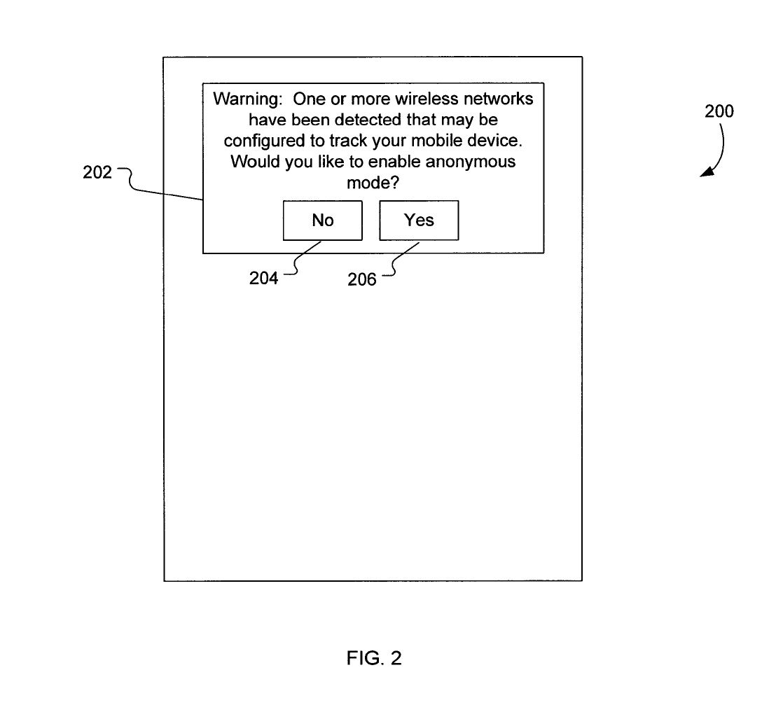

FIG. 2 illustrates an example graphical user interface 200 for presenting a warning about device tracking. GUI 200 can include popup GUI 202 (e.g., a graphical prompt) for presenting a warning to the user. For example, GUI 202 can warn the user of the mobile device that the mobile device may be tracked by one or more wireless networks detected by the mobile device. GUI 202 can prompt the user to enable an anonymous networking mode of the mobile device. For example, a user can select graphical element 204 to continue using the mobile device without making any changes to the configuration of the mobile device. The user can select graphical element 206 to enable anonymous networking on the mobile device.

Hiding Device Identifier at the Mobile Device

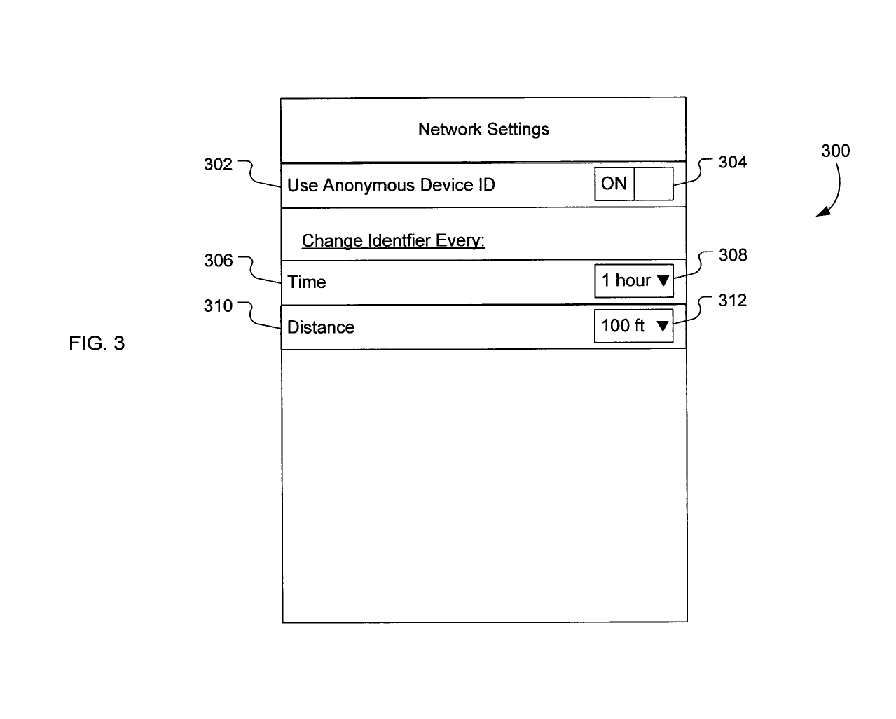

FIG. 3 illustrates an example graphical user interface 300 for configuring network settings on a mobile device. For example, GUI 300 can be displayed in response to a user selecting graphical element 206 of FIG. 2. GUI 300 can be displayed in response to a user providing input to a configurations user interface (not shown) of the mobile device. GUI 300 can include graphical element 302 including interactive graphical element 304. For example, graphical element 302 can present a network configuration option that allows a user to enable anonymous networking (e.g., “use anonymous device ID”) on the mobile device. The user can select interactive graphical element 304 to enable or disable anonymous networking, for example.

In some implementations, when anonymous networking is enabled, the mobile device can automatically generate an anonymous device identifier (e.g., random MAC address) when a predefined event is detected. For example, the predefined events can include an elapsed period of time, a change in location and/or a change in network association. Every time a predefined event is detected a new random device identifier can be generated by the mobile device. For example, GUI 300 can include graphical element 306 and interactive graphical element 308. Graphical element 306 can provide a mechanism (e.g., graphical element 308) for specifying a maximum period of time to use a generated anonymous device identifier. For example, interactive graphical element 308 can be a pull down menu that lists various periods of time (e.g., 15 minutes, 30 minutes, 1 hour, 1 day, etc.) that a user can select to specify how long (e.g., maximum amount of time) an anonymous device identifier should be used. If the user selects 15 minutes as the period of time, a new random device identifier will be generated every 15 minutes. The random device identifier will be provided to network devices (e.g., wireless access points) when the mobile device communicates with the network devices. For example, instead of providing the actual MAC address of the mobile device to network devices when probing or connecting to a network, the mobile device can generate a random MAC address and provide the random MAC address to the network devices when communicating with the network devices.

In some implementations, a new random device identifier can be generated in response to detecting a change in location of the mobile device. For example, if the user has enabled anonymous networking by selecting interactive graphical element 304, the mobile device can automatically generate a new random device identifier when the mobile device detects that its location has changed. In some implementations, the mobile device can detect a change in location by determining that the mobile device has moved a threshold distance. For example, GUI 300 can include graphical element 310 and interactive graphical element 312 for specifying the threshold distance for random device identifier generation. For example, the mobile device can use global satellite positioning system signals, Wi-Fi signals, dead reckoning techniques or other well-known technologies to determine the location or movement of the mobile device. The current location of the mobile device can be compared to a previous location of the mobile device to determine a distance traveled by the mobile device. If the mobile device detects that the determined distance traveled exceeds the distance threshold specified by the user, the mobile device can automatically generate a new random device identifier for identifying the mobile device to the network.

In some implementations, a change in location can be detected based on detected networks. For example, the mobile device can send a Wi-Fi probe request to determine which Wi-Fi networks are reachable by the mobile device. Each Wi-Fi network that receives the probe request can respond with an identifier (e.g., service set identifier “SSID”) of the Wi-Fi network. In some implementations, the mobile device can passively monitor wireless network traffic to determine which networks are available proximate to the mobile device's location. The mobile device can store information that identifies the responding or monitored Wi-Fi networks. If the mobile device sends out a subsequent Wi-Fi probe request and receives responses from Wi-Fi networks that include different network identifiers than the previous probe request or if the mobile device determines that monitored network traffic includes new or different network identifiers, then the mobile device can determine that the location of the mobile device has changed and automatically generate a new anonymous device identifier.

In some implementations, a change of location can be detected based on global navigation satellite system (GNSS) positioning data. For example, the mobile device can periodically determine its location based on GNSS data. The mobile device can store the determined location in local memory, hard drive or other computer readable media. The mobile device can determine its current GNSS-based location and compare it to a previously determined GNSS-based location. If the current location is different than the previous location, then the mobile device can determine that the mobile device has changed location and automatically generate a new random device identifier. For example, the mobile device can detect a change in location if the location exceeds a threshold distance (e.g., the user-specified threshold distance described above with reference to item 312).

In some implementations, a change of location can be detected based on a change in network association. For example, the mobile device can be associated with (e.g., joined to, connected to) a wireless network having an identifier SSID1. The mobile device can move to a different location, store, building, etc., where the mobile device disassociates from wireless network SSID1. For example, the mobile device may move far enough away from network SSID1 that the mobile device can no longer maintain a connection. Upon disassociating from network SSID1, the mobile device can automatically generate a new random device identifier.

In some implementations, the mobile device can generate a new random device identifier before connecting to a new network. For example, the mobile device can send a Wi-Fi probe request to determine available networks. The mobile device can prompt the user to select an available network to connect to or the mobile device can automatically select a network that the mobile device has previously connected to. The mobile device can compare the previous network identifier (SSID1) to a network identifier (SSID2) that the mobile device is about to connect to. Before connecting to SSID2, the mobile device can automatically generate a new random device identifier. Thus, when the mobile device connects to network SSID2, the mobile device will use a different device identifier than the device identifier that was used to connect the mobile device to SSID1. By using different device identifiers, the mobile device can prevent tracking of the mobile device across different networks.

In some implementations, the mobile device can generate a new random device identifier when connecting to a new wireless access point. For example, a wireless network can include several wireless access points to service wireless connections to the network. The mobile device can detect when the mobile device changes from one wireless access point to another wireless access point on the same network and generate a new random device identifier upon detecting the change in wireless access point connection. In some implementations, the mobile device will not generate a new random device identifier when changing wireless access points associated with the same wireless network. For example, by using the same random device identifier to connect to access points on the same network, the mobile device can avoid the bandwidth, processing overhead, and time required for security processes associated with reconnecting to the network using a different device identifier.

In some implementations, the mobile device can generate a new random device identifier for each Wi-Fi probe request. For example, each probe request sent by the mobile device can include the identifier (e.g., MAC address) of the mobile device. Even if the mobile device does not connect to a network, the network can still receive and track the mobile device using the identifier received in the probe request. Thus, in some implementations, every time the mobile device sends out a Wi-Fi probe request the mobile device can generate a new random device identifier to send out in the probe request to prevent the wireless networks from receiving the actual device identifier of the mobile device. Moreover, by using different random device identifiers, instead of just one random device identifier, the mobile device can prevent a tracking system from correlating the random device identifier to the mobile device. If a mobile device has an active association to one network while using random device identifier A, it may generate new random device identifiers for the purpose of discovering additional access points and wireless networks with each probe request, but it may return to using identifier A if it does not elect to change networks.

Hiding Device Identifier at the Server

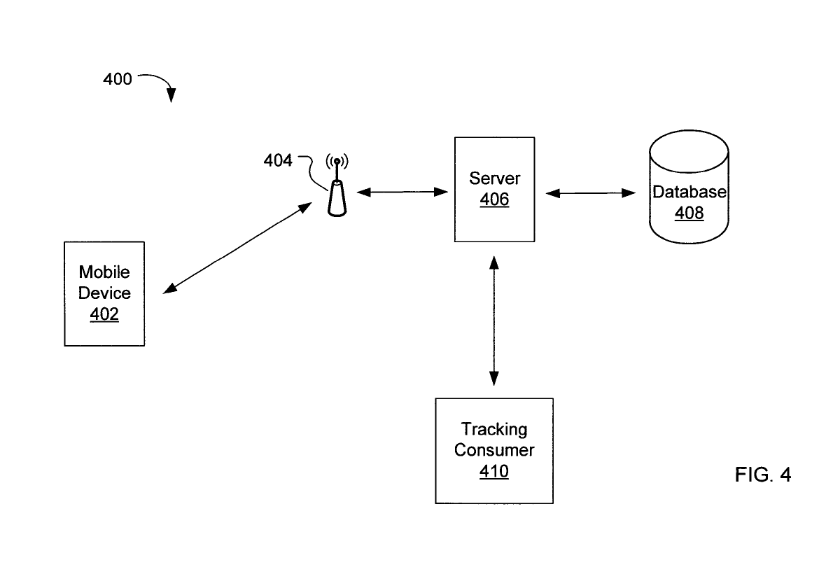

FIG. 4 illustrates an example system 400 for tracking mobile devices. In some implementations, system 400 can be configured to receive a device identifier (e.g., MAC address) from mobile device 402 when mobile device 402 connects to a network through wireless access point 404. For example, mobile device 402 can broadcast a network probe request that includes the MAC address of mobile device 402. Wireless access point 404 can respond to the probe request by sending information (e.g., network identifier, SSID, etc.) for connecting to the network through wireless access point 404.

In some implementations, wireless access point 404 can transmit the device identifier received from mobile device 402 to server 406. For example, server 406 can collect mobile device identifiers, mobile device location information and other information about mobile devices that connect to wireless access point 404 and store the information, in association with the mobile device identifiers, in database 408. For example, the server can determine the location of the mobile device 402 based on the location of the wireless access point 404. When the mobile device 402 connects to the network through wireless access point 404, the server 406 can collect information identifying websites or other information accessed through the network by the mobile device 402.

In some implementations, server 406 can receive a request for mobile device tracking information from tracking consumer 410. Tracking consumer 410 can be a computing device associated with a consumer of mobile device tracking information. For example, retail stores in a shopping mall can be a consumer of mobile device tracking information. The retail stores can use the mobile device tracking information to determine the effectiveness of product placement throughout the store, advertising or other business generation activities.

In some implementations, when server 406 receives a request for mobile device tracking information from tracking consumer 410, server 406 can respond by sending the tracking consumer 410 anonymous device tracking information. For example, instead of sending tracking consumer 410 the actual device identifiers (e.g., MAC addresses) stored in database 408, the server can replace the actual device identifiers with random device identifiers (e.g., random MAC addresses). For example, all instances of a particular device identifier can be replaced with a single random identifier such that all data associated with a single device can still be tracked without giving the tracking consumer the actual device identification information.

In some implementations, the server 406 can generate two different random device identifiers for the same device. For example, mobile device 402 can be tracked by server 406 when the mobile device 402 sends probe requests that are received by wireless access point 404. Thus, even though the mobile device (or user) has not connected to, joined or opted-in to the services provided by the network serviced by wireless access point 404, the server 406 can track the location of mobile device 402. If the user selects to have mobile device 402 join the network through wireless access point 404, the user has opted-in to the network and the server can track additional information about the mobile device, such as websites visited. The server can store information (e.g., actual device identifier and timestamp) identifying when the mobile device opted-in to the network.

In some implementations, the server 406 can generate one anonymous device identifier for tracking information associated with mobile device 402 before the user opts-in or joins the network and generate another anonymous device identifier for tracking information associated with mobile device 402 for tracking information collected after the user opts-in or joins the network. Thus, when tracking consumer 410 receives the mobile device tracking information from server 406, tracking consumer 410 will not be able to determine that the before opt-in and after opt-in tracking information correspond to the same mobile device. Thus, because the actual device identifier of mobile device 402 is never shared with tracking consumer 410, the identity of mobile device 402 and its user can be protected from inadvertent disclosure by the tracking consumer 410.

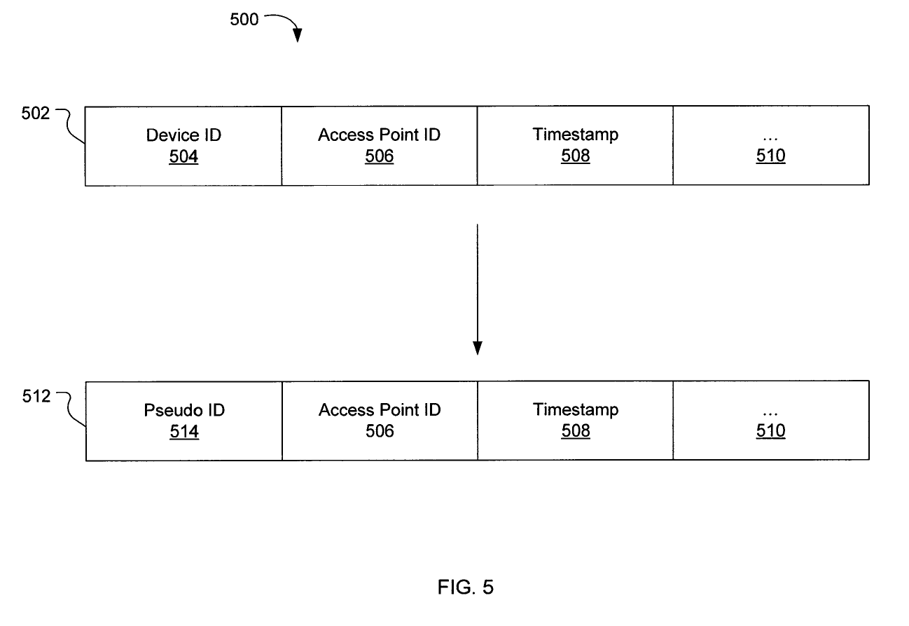

FIG. 5 illustrates an example of mobile device tracking records 500. For example, mobile device tracking record 502 can be a mobile device tracking stored in database 408 of FIG. 4. Mobile device tracking record can include an actual device identifier 504 (e.g., the actual MAC address of mobile device 402), an access point identifier 506, a timestamp 508 and additional information 510 (e.g., website address) associated with a tracking event entry in database 408. A tracking event can be a mobile device accessing a network, receiving a probe request from a mobile device, detecting a webpage request through the network, or any other trackable event. The access point identifier 506 and timestamp 508 can be used to determine the location of the mobile device identified by device ID 504 at the recorded timestamp 508. The location of the mobile device can be the location of the identified access point, for example.

In some implementations, when server 406 sends mobile device tracking information to tracking consumer 410, server 406 can generate tracking record 512. For example, server 406 can convert tracking record 502 into tracking record 512 for transmission to tracking consumer 410. Server 406 can replace the actual device identifier 504 in tracking record 502 with a pseudo device identifier 514 to create tracking record 512. In some implementations, the pseudo device identifier 514 can be a pre-opt-in device identifier or a post-opt-in identifier, as described above. For example, the pseudo device identifier 514 can be a randomly generated device identifier (e.g., random MAC address) that can be used to correlate records associated with a single device. Once tracking record 512 is generated with the actual device identifier replaced by the pseudo device identifier, tracking record 512 can be transmitted to tracking consumer 410. Thus, the mobile device's actual device identifier and pre-opt-in and post-opt-in activities can be protected.

Example Processes

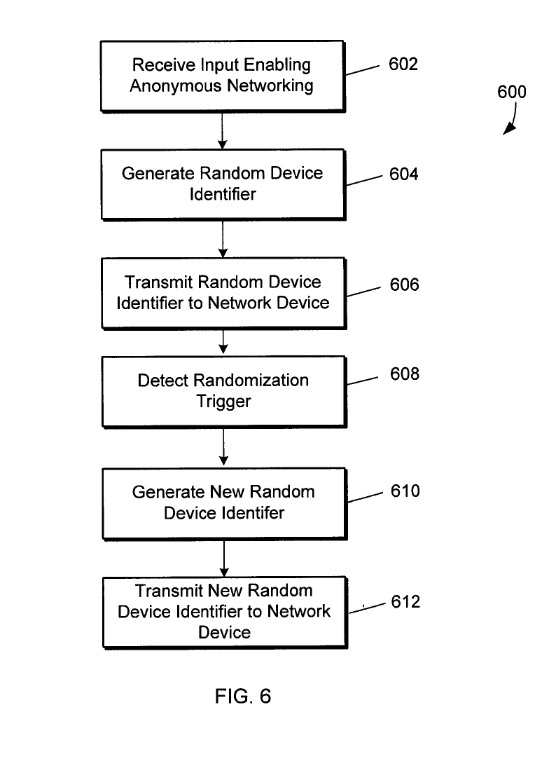

FIG. 6 is flow diagram of an example process 600 for generating anonymous device identifiers. For example, a mobile device can be configured to generate anonymous device identifiers and transmit the anonymous device identifiers to a network when communicating with the network. The anonymous device identifier can be a random MAC address, for example. The network can be a Wi-Fi network, Bluetooth network or any other type of wireless network, for example.

At step 602, the mobile device can receive input enabling anonymous networking. For example, the mobile device can prompt the user to enable anonymous networking when a wireless network is detected by the mobile device. The user can provide input to turn on or enable anonymous networking on the mobile device through a configuration graphical user interface of the mobile device, for example. The manufacturer or seller of a mobile device may also elect to enable this option on behalf of the user.

At step 604, the mobile device can generate a random device identifier. For example, the mobile device can generate a random MAC address to send to network devices when communicating with the network devices.

At step 606, the mobile device can transmit the random device identifier to a network device. For example, the mobile device can transmit the random device identifier in a network probe request or any other type of communication with network devices. The mobile device can transmit the random device identifier instead of the actual device identifier (e.g., actual MAC address) of the mobile device.

At step 608, the mobile device can detect a device identifier randomization trigger. For example, the randomization trigger can be a change in location, change in network association and/or elapsed time period, as described above.

At step 610, the mobile device can generate a new random device identifier. For example, in response to detecting the device identifier randomization trigger, the mobile device can generate a new random device identifier to use when communicating with network devices.

At step 612, the mobile device can transmit the new random device identifier to a network device. For example, the mobile device can transmit the new random device identifier to a network device (e.g., a wireless access point, router, server, etc.) when probing for a network to connect to or when connected to a network and utilizing network resources.

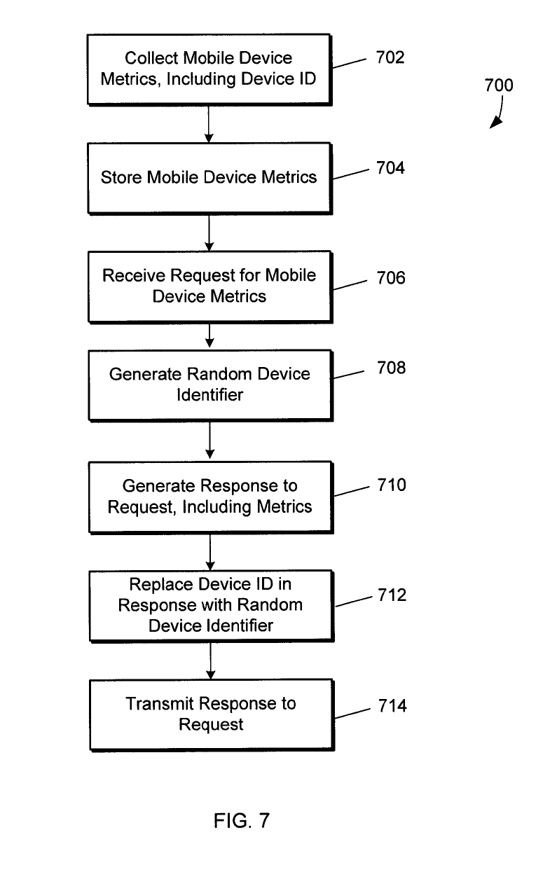

FIG. 7 is a flow diagram of an example process 700 for obfuscating device identifiers when exporting tracking information. For example, a server can be configured store actual device identifiers when collecting device tracking information. However, when exporting the tracking information, the server can be configured to replace the actual device identifiers with randomly generated device identifiers.

At step 702, the server can collect mobile device tracking metrics including actual device identifiers for the mobile devices. At step 704, the server can store the mobile device metrics. For example, the server can store the mobile device tracking metrics in a database for later correlation and retrieval.

At step 706, the server can receive a request for mobile device tracking metrics. For example, the server can receive a request for the mobile device tracking metrics from a tracking consumer, as described above with reference to FIG. 4.

At step 708, the server can generate a random device identifier. For example, for each actual device identifier stored in the database, the server can generate a random device identifier that can be used to correlate database records associated with the same device and that does not actually identify the mobile device that was tracked. The server can generate a pre-opt-in random identifier and a post-opt-in random identifier for a mobile device, as described above. The random device identifier (e.g., random MAC address) can be generated in response to the request from the tracking consumer at step 706.

At step 710, a response to the tracking consumer's request can be generated. The response can include the tracking metrics stored in the device tracking database. At step 712, the server can replace the actual device identifier in the response with the random device identifier generated at step 708. At step 714, the server can transmit the response with the random device identifiers to the tracking consumer.

Example System Architecture

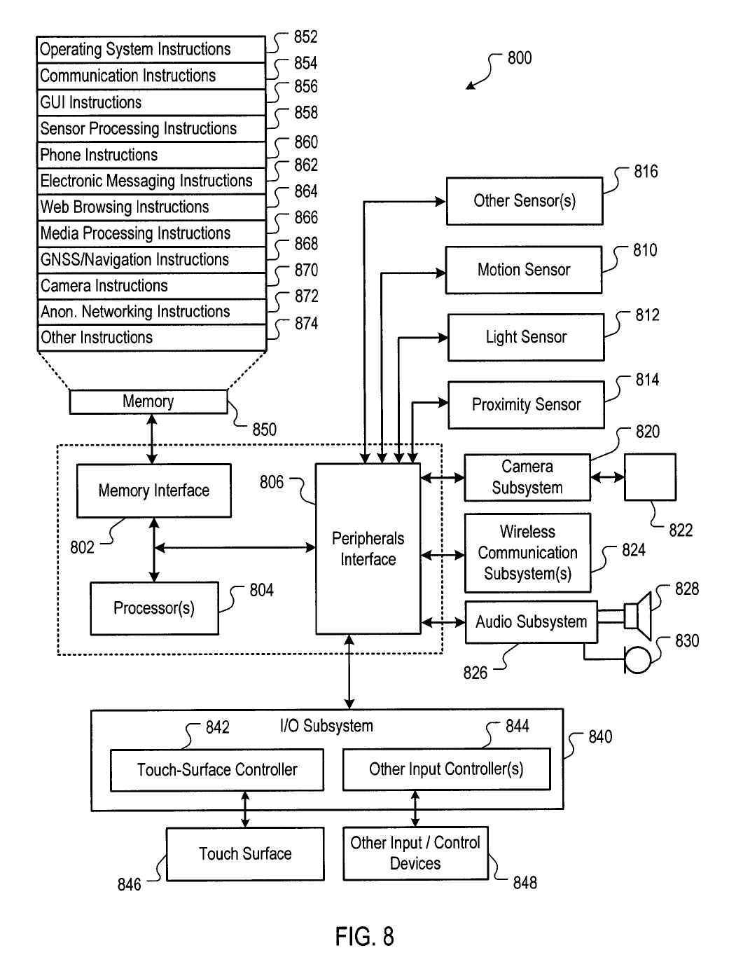

FIG. 8 is a block diagram of an example computing device 800 that can implement the features and processes of FIGS. 1-7. The computing device 800 can include a memory interface 802, one or more data processors, image processors and/or central processing units 804, and a peripherals interface 806. The memory interface 802, the one or more processors 804 and/or the peripherals interface 806 can be separate components or can be integrated in one or more integrated circuits. The various components in the computing device 800 can be coupled by one or more communication buses or signal lines.

Sensors, devices, and subsystems can be coupled to the peripherals interface 806 to facilitate multiple functionalities. For example, a motion sensor 810, a light sensor 812, and a proximity sensor 814 can be coupled to the peripherals interface 806 to facilitate orientation, lighting, and proximity functions. Other sensors 816 can also be connected to the peripherals interface 806, such as a global navigation satellite system (GNSS) (e.g., GPS receiver), a temperature sensor, a biometric sensor, magnetometer or other sensing device, to facilitate related functionalities.

A camera subsystem 820 and an optical sensor 822, e.g., a charged coupled device (CCD) or a complementary metal-oxide semiconductor (CMOS) optical sensor, can be utilized to facilitate camera functions, such as recording photographs and video clips. The camera subsystem 820 and the optical sensor 822 can be used to collect images of a user to be used during authentication of a user, e.g., by performing facial recognition analysis.

Communication functions can be facilitated through one or more wireless communication subsystems 824, which can include radio frequency receivers and transmitters and/or optical (e.g., infrared) receivers and transmitters. The specific design and implementation of the communication subsystem 824 can depend on the communication network(s) over which the computing device 800 is intended to operate. For example, the computing device 800 can include communication subsystems 824 designed to operate over a GSM network, a GPRS network, an EDGE network, a Wi-Fi or WiMax network, and a Bluetooth™ network. In particular, the wireless communication subsystems 824 can include hosting protocols such that the device 100 can be configured as a base station for other wireless devices.

An audio subsystem 826 can be coupled to a speaker 828 and a microphone 830 to facilitate voice-enabled functions, such as speaker recognition, voice replication, digital recording, and telephony functions. The audio subsystem 826 can be configured to facilitate processing voice commands, voiceprinting and voice authentication, for example. The microphone may also be used to detect audio signals that indicate movement of the mobile device.

The I/O subsystem 840 can include a touch-surface controller 842 and/or other input controller(s) 844. The touch-surface controller 842 can be coupled to a touch surface 846. The touch surface 846 and touch-surface controller 842 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 846.

The other input controller(s) 844 can be coupled to other input/control devices 848, such as one or more buttons, rocker switches, thumb-wheel, infrared port, USB port, and/or a pointer device such as a stylus. The one or more buttons (not shown) can include an up/down button for volume control of the speaker 828 and/or the microphone 830.

In one implementation, a pressing of the button for a first duration can disengage a lock of the touch surface 846; and a pressing of the button for a second duration that is longer than the first duration can turn power to the computing device 800 on or off Pressing the button for a third duration can activate a voice control, or voice command, module that enables the user to speak commands into the microphone 830 to cause the device to execute the spoken command. The user can customize a functionality of one or more of the buttons. The touch surface 846 can, for example, also be used to implement virtual or soft buttons and/or a keyboard.

In some implementations, the computing device 800 can present recorded audio and/or video files, such as MP3, AAC, and MPEG files. In some implementations, the computing device 800 can include the functionality of an MP3 player, such as an iPod™. The computing device 800 can, therefore, include a 36-pin connector that is compatible with the iPod. Other input/output and control devices can also be used.

The memory interface 802 can be coupled to memory 850. The memory 850 can include high-speed random access memory and/or non-volatile memory, such as one or more magnetic disk storage devices, one or more optical storage devices, and/or flash memory (e.g., NAND, NOR). The memory 850 can store an operating system 852, such as Darwin, RTXC, LINUX, UNIX, OS X, WINDOWS, or an embedded operating system such as VxWorks.

The operating system 852 can include instructions for handling basic system services and for performing hardware dependent tasks. In some implementations, the operating system 852 can be a kernel (e.g., UNIX kernel). In some implementations, the operating system 852 can include instructions for performing voice authentication. For example, operating system 852 can implement the anonymous networking and device tracking features as described with reference to FIGS. 1-7.

The memory 850 can also store communication instructions 854 to facilitate communicating with one or more additional devices, one or more computers and/or one or more servers. The memory 850 can include graphical user interface instructions 856 to facilitate graphic user interface processing; sensor processing instructions 858 to facilitate sensor-related processing and functions; phone instructions 860 to facilitate phone-related processes and functions; electronic messaging instructions 862 to facilitate electronic-messaging related processes and functions; web browsing instructions 864 to facilitate web browsing-related processes and functions; media processing instructions 866 to facilitate media processing-related processes and functions; GNSS/Navigation instructions 868 to facilitate GNSS and navigation-related processes and instructions; and/or camera instructions 870 to facilitate camera-related processes and functions.

The memory 850 can store other software instructions 872 to facilitate other processes and functions, such as the anonymous networking and device tracking processes and functions as described with reference to FIGS. 1-7.

The memory 850 can also store other software instructions 874, such as web video instructions to facilitate web video-related processes and functions; and/or web shopping instructions to facilitate web shopping-related processes and functions. In some implementations, the media processing instructions 866 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. The memory 850 can include additional instructions or fewer instructions. Furthermore, various functions of the computing device 800 can be implemented in hardware and/or in software, including in one or more signal processing and/or application specific integrated circuits.

What is claimed is:

1. A method comprising:
determining, by a mobile device having an actual device identifier, that anonymous networking has been enabled on the mobile device;
detecting a trigger for generating a random device identifier for the mobile device;
in response to detecting the trigger, generating a random device identifier for the mobile device; and
transmitting the random device identifier to a network device instead of the actual device identifier.

2. The method of claim 1, wherein the actual device identifier is the media access control address of the mobile device and wherein the random device identifier is a randomly generated media access control address generated by the mobile device.

3. The method of claim 1, wherein the trigger is a change in location of the mobile device.

4. The method of claim 1, wherein the trigger is a change in network connected to by the mobile device.

5. The method of claim 1, wherein the trigger is an elapsed period of time.

6. A system comprising:
a processor-based application, which when executed on a computer, will cause the processor to:
determine, by a mobile device having an actual device identifier, that anonymous networking has been enabled on the mobile device;
detect a trigger for generating a random device identifier for the mobile device;
in response to detecting the trigger, generating a random device identifier for the mobile device; and
transmit the random device identifier to a network device instead of the actual device identifier.

7. The system of claim 6, wherein the actual device identifier is the media access control address of the mobile device and wherein the random device identifier is a randomly generated media access control address generated by the mobile device.

8. The system of claim 6, wherein the trigger is a change in location of the mobile device.

9. The system of claim 6, wherein the trigger is a change in network connected to by the mobile device.

10. The system of claim 6, wherein the trigger is an elapsed period of time.

11. A computer program product comprising computer-readable program code to be executed by one or more processors when retrieved from a non-transitory computer-readable medium, the program code including instructions to:
determine, by a mobile device having an actual device identifier, that anonymous networking has been enabled on the mobile device;
detect a trigger for generating a random device identifier for the mobile device;
in response to detecting the trigger, generating a random device identifier for the mobile device; and
transmit the random device identifier to a network device instead of the actual device identifier.

12. The computer program product of claim 11, wherein the actual device identifier is the media access control address of the mobile device and wherein the random device identifier is a randomly generated media access control address generated by the mobile device.

13. The computer program product of claim 11, wherein the trigger is a change in location of the mobile device.

14. The computer program product 11, wherein the trigger is a change in network connected to by the mobile device.

15. The computer program product of claim 11, wherein the trigger is an elapsed period of time.

16. A method comprising:
receiving, at a first computing device, metrics associated with a mobile device, the metrics including an actual device identifier of the mobile device;
storing the metrics;
receiving, at the first computing device from a second computing device, a request for the metrics;
generating a response to the request, including the metrics;
replacing the actual device identifier in the response with a random device identifier; and
transmitting the response to the second computing device.

17. The method of claim 16, wherein the actual device identifier is a media access control address of the mobile device and wherein the random device identifier is a randomly generated media access control address generated by the first computing device.

18. A computer program product comprising computer-readable program code to be executed by one or more processors when retrieved from a non-transitory computer-readable medium, the program code including instructions to:
receive, at a first computing device, metrics associated with a mobile device, the metrics including an actual device identifier of the mobile device;
store the metrics;
receive, at the first computing device from a second computing device, a request for the metrics;
generate a response to the request, including the metrics;
replace the actual device identifier in the response with a random device identifier; and
transmit the response to the second computing device.

19. The computer program product of claim 18, wherein the actual device identifier is a media access control address of the mobile device and wherein the random device identifier is a randomly generated media access control address generated by the first computing device.
